(19) United States
(12) Patent Application Publication
(10) Pub. No.: US 2007/0139035 A1
(43) Pub. Date: Jun. 21, 2007

(54) MAGNETIZED PULSAR RING

(75) Inventors: Yasuhiko ISHII, Kashiwara-shi (JP); Naoki Morimura, Kashiba-shi (JP); Katsura Koyagi, Kashiwara-shi (JP); Tetsuaki Numata, Kitakatsuragi-gun (JP); Nobutsuna Motohashi, Katsuragi-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: JTEKT Corporation, Osaka-shi (JP)

(21) Appl. No.: 11/611,581

(22) Filed: Dec. 15, 2006

(30) Foreign Application Priority Data
Dec. 16, 2005 (JP) 2005-362726
Dec. 16, 2005 (JP) 2005-362727
Nov. 2, 2006 (JP) 2006-298354

(51) Int. Cl. G01P 3/48

(52) U.S. Cl. 324/174

(57) ABSTRACT

A magnetized body (12) is constituted by a resin bonded magnet, and is fixed to a support member (11) in accordance with an integral injection molding, in such a manner that a come-off preventing portion (15) engaging with an outer peripheral portion of a flange portion (14) is formed in an outer periphery of the magnetized body (12). An elastic layer (17) is interposed between the magnetized body (12) and the flange portion (14) A side surface of the flange portion (14) is provided with a concave portion (16) having a depth corresponding to a thickness of the elastic layer (17).

### BACKGROUND OF THE INVENTION

The present invention relates to a magnetized pulsar ring used in a rolling bearing apparatus with sensor or the like capable of detecting a rotation speed.

In a railway vehicle or a motor vehicle, in order to Support an axle or a rotation shaft transmitting a rotation to the axle and detect a rotation speed of the axle or the rotation shaft, there is used a rolling bearing apparatus with sensor as shown in FIG. 14 (refer to Japanese Unexamined Patent Publication No. 2003-279587).

In FIG. 14, the rolling bearing apparatus with sensor is provided with a rolling bearing 41, a sensor apparatus 42 provided in the rolling bearing 41 and a magnetized pulsar ring 43 corresponding to a detected portion.

The rolling bearing 41 is provided with an outer ring 44 corresponding to a fixed ring, an inner ring 45 corresponding to a rotating ring, and a plurality of balls 46 corresponding to a plurality of rolling elements arranged therebetween.

The magnetized pulsar ring 43 is constituted by a support member 47 fixed to the inner ring 45, and a magnetized body 48 provided in the support member 47.

The sensor apparatus 42 has a case 49 fixed to the outer ring 44, and a magnetic sensor 50 provided within the case 49, and is faced to the magnetized pulsar ring 43 from an outer side in an axial direction.

The support member 47 of the magnetized pulsar ring 43 is constituted by a cylinder portion 47a fitted and fixed to an outer periphery of the inner ring 45, and an outward flange portion 47b provided in a right end portion of the cylinder portion 47a, and is relatively rotated with respect to the magnetic sensor 50 so as to generate a magnetic flux density change.

There is a case that the magnetized pulsar ring mentioned above is structured such as to be integrally formed with the seal apparatus. As the rolling bearing apparatus with sensor using this magnetized pulsar ring, there has been known the rolling bearing apparatus constituted by a rolling bearing 51 having a fixed ring 52, a rotating ring 53 and a rolling element 54 arranged between both the rings 52 and 53, a fixed side seal member 55 having a cored bar 56 fitted and fixed to the fixed ring 52 and an elastic seal 57 attached to the cored bar 56, a rotating side seal member 58 having a cylinder portion 59 fitted and fixed to the rotating ring 53 and a flange portion 60 connected to an end portion in an axial direction of the cylinder portion 59 and extending toward the fixed side seal member 55, a sensor 61 supported to the fixed side seal member 55 via a resin 62, and a magnetized body 63 provided in a side surface of the flange portion 60 of the rotating side seal member 58, as shown in FIG. 15 (refer to Japanese Unexamined Patent Publication No. 2005-098387). In this rolling bearing apparatus with sensor, the rotating side seal member 58 and the magnetized body 63 correspond to the magnetized pulsar ring, and there is an advantage that it is possible to previously assemble (pack) the fixed side seal member 55 with the sensor 61 and the rotating side seal member 58 with the magnetized body 63 (the magnetized pulsar ring).

In the magnetized pulsar ring mentioned above, there is a case that the magnetized body formed by magnetizing magnetic powders having a rubber as a binder is damaged by a foreign material or the like.

Accordingly, there can be considered that a scratch resistance is increased by employing the magnetized body as a resin bonded magnet. However, in the case that the resin bonded magnet is used, the resin bonded magnet is relatively weak for a thermal shock and tends to be cracked, so that it is hard to fix the magnetized body to the support member.

### SUMMARY OF THE INVENTION

An object of the present invention is to provide a magnetized pulsar ring which increases a scratch resistance by employing a resin bonded magnet as a magnetized body, and improves a thermal impact resistance and securely fixes a magnetized body in the case of using a resin bonded magnet.

In accordance with this invention, there is provided a magnetized pulsar ring including:

a support member including a cylinder portion and a flange portion provided in one end of the cylinder portion; and

a disc-shaped magnetized body provided in the flange portion of the support member,

wherein the magnetized body is constituted by a resin bonded magnet, and an elastic layer is interposed between the magnetized body and the flange portion.

In the magnetized pulsar ring in accordance with this invention, as the resin bonded magnet, it is possible to suitably employ ferrite powder+PPS (polyphenyl sulfide resin), ferrite powder+PA66 or PA12 or PA612 (polyamide resin), rare earth magnetic powder+PPS, rare earth magnetic powder+PA66 or PAl2 or PA612, ferrite powder+rare earth magnetic powder +PPS, ferrite powder+rare earth magnetic powder+PA66 or PA12 or PA612 and the like. It is possible to employ combinations of the other magnetic powders and resins. Further, it is possible to add a reinforcement such as a glass fiber or the like to the resin. As the support member, a ferritic stainless steel such as SUS430 is suitable.

In the magnetized pulsar ring in accordance with this invention, there is a case that the resin bonded magnet is integrally injection molded with the support member (a slinger), and is magnetized by a magnetizing apparatus in such a manner that N poles and S poles are arranged at a uniform interval, and there is a case that the resin bonded magnet is fixed to the support member (the slinger) via an adhesive agent layer, and is thereafter magnetized by the magnetizing apparatus in such a manner that the N poles and the S poles are arranged at a uniform interval.

In the magnetized pulsar ring in accordance with this invention, the support member is made of a metal such as a stainless steel or the like, whereby the resin bonded magnet and the support member are structured such as to have different linear expansion coefficients. Accordingly, an amount of deformation is different between the magnetized body and the support member at a thermal expanding time or a thermal contracting time, and the magnetized body tends to be cracked with respect to a thermal shock. Then, in accordance with the magnetized pulsar ring of this invention, since an elastic layer is interposed between the magnetized body and the flange portion, the difference in the amount of deformation is absorbed by the elastic layer, whereby a stress generated in the magnetized body becomes small, so that the magnetized body is prevented from being damaged,

As the elastic layer, it is possible to use a rubber sheet (a rubber layer), a resin sheet (a resin layer), an adhesive agent (an adhesive agent layer) and the like. The elastic layer can be constituted by two layers or more without being limited to one layer, and can be, for example, formed as a two-layer structure having a first adhesive agent layer adhered to the support member and a second adhesive agent layer adhered to the magnetized body, or formed as a three-layer structure having a first adhesive agent layer adhered to the support member, a second adhesive agent layer adhered to the magnetized body, and an additional elastic layer (hereinafter, refer to as “intermediate elastic layer”) interposed between both the adhesive agent layers. A material of the rubber layer used as the elastic layer is preferably excellent in a heat resistance, and can employ a nitrile rubber (NBR), a hydrogenated nitrile rubber (HNBR), a fluorine-contained rubber (FKM), a silicone rubber (VMQ), an ethylene propylene rubber (EPDM) and the like.

In the case that the intermediate elastic layer interposed between the adhesive agent layers in the three-layer structure, there is a case that the magnetized body is integrally formed with the support member in accordance with an insert molding, and may be adhered to the support member by an adhesive agent after previously molding. Further, it is possible to separately execute a step of adhering the rubber layer to the support member via the first adhesive agent layer, and a step of adhering the magnetized body to the rubber layer via the second adhesive agent layer, or it is possible to execute all the adhesions, for example, at the same time as the insert molding time. The adhesion between the rubber layer and the support member and/or the magnetized body may be executed by a vulcanizing adhesion.

In the magnetized pulsar ring in accordance with this invention, the magnetized body may be fixed to the support member in accordance with an integral injection molding, in such a manner that a come-off preventing portion that engages with an outer peripheral portion of the flange portion is formed in an outer periphery of the magnetized body. In accordance with this magnetized pulsar ring, since the come-off preventing portion engaging with the outer peripheral portion of the flange portion is formed in the outer periphery of the magnetized body, it is possible to prevent the magnetized body from coming off from the support member. Further, it is possible to shorten a manufacturing step so as to lower a cost by employing the integral injection molding.

Since the come-off preventing portion is weaker in comparison with the other portions (a perforated disc-shaped signal output portion) of the magnetized body, and a stress tends to be concentrated to the come-off preventing portion, the come-off preventing portion comes to a weakest position against the thermal shock. In the magnetized pulsar ring provided with the come-off preventing portion, it is preferable that a further thermal shock countermeasure is applied in addition to the elastic layer.

The come-off preventing portion can be made unnecessary by modifying the structure of the elastic layer, or employing any structure in place of the come-off preventing portion. In this case, durability is improved by doing away with the come-off preventing portion which is relatively weak against the thermal shock. In the case that the come-off preventing portion is made unnecessary, the magnetized pulsar ring can be, of course, structured by the support member constituted by the cylinder portion and the flange portion provided in one end of the cylinder portion, and the disc-shaped magnetized body provided in the flange portion of the support member, but can be structured by a cylindrical support member and a cylindrical magnetized body provided in an outer periphery or an inner periphery thereof

In the magnetized pulsar ring in accordance with this invention, a linear expansion coefficient adjusting material making a linear expansion coefficient of the magnetized body close to a linear expansion coefficient of the support member may be added to the magnetized body. In accordance with this structure, the amounts of deformation become equal between the magnetized body and the support member at the thermal expanding time or the thermal contracting time, and the stress generated in the magnetized body becomes small. This structure becomes particularly effective in the case that the come-off preventing portion is provided in the magnetized body.

In the magnetized pulsar ring provided with the come-off preventing portion, a corner portion of the flange portion may be chamfered. In accordance with this structure, the come-off preventing portion can be made thick as well as a stress applied to the come-off preventing potion is dispersed, so that the stress generated in the come-off preventing portion becomes smaller. The chamfer is executed before the integral injection molding, and a chamfered portion is replaced by the resin bonded magnet by using the same metal mold as the flange portion with no chamfer, whereby the thickening of the come-off preventing portion can be achieved. A shape of the chamfered portion may be, of course, formed as a flat slope surface, but can be formed as a curved surface. Further, the chamfer may be applied to only one side (only an outer corner in an axial direction), or may be applied to both sides.

Further, in the magnetized pulsar ring in accordance with this invention, it is preferable that a side surface of the flange portion has a concave portion having a depth corresponding to the thickness of the elastic layer. In accordance with this structure, it is not necessary to make the magnetized body thin, but it is possible to securely prevent the thermal shock resistance from being lowered and prevent the magnetized body from easily coming off. In this case, the elastic layer may be constituted by the adhesive agent layer having only one layer. In this case, the concave portion is provided for accommodating the adhesive agent layer, and it is easy to control the thickness of the adhesive agent layer. In this case, the depth corresponding to the thickness of the elastic layer is not necessarily equal to an entire thickness of the elastic layer. In the case of the three-layer structure elastic layer, the depth of the concave portion may be set to the same magnitude as the thickness of the first adhesive agent layer, or a magnitude obtained by adding the-first adhesive agent layer and the intermediate elastic layer, or the other magnitude.

Further, in the magnetized pulsar ring in accordance with this invention, the magnetized pulsar ring may include a first adhesive agent layer adhered to the support member, a second adhesive agent layer adhered to the magnetized body, and an elastic layer interposed between both the adhesive agent layers. In this case, since the adhesive agent layer serves as the elastic layer, it is possible to absorb the difference of the amount of deformation between the support member and the magnetized body, by the three-layer structure elastic layer. Further, since the structure is made such as to have the first adhesive agent layer adhered to the support member, the second adhesive agent layer adhered to the magnetized body, and the intermediate elastic layer (the third adhesive agent layer, the rubber layer, the resin layer or the like) interposed between both the adhesive agent layers, it is possible to use the adhesive agents which are respectively compatible with the support member and the magnetized body, and it is possible to securely prevent the magnetized body from easily coming off Accordingly, in this magnetized pulsar ring, it is easy to omit the come-off preventing portion.

Further, in the magnetized pulsar ring in accordance with this invention, a relative rotation preventing concave portion or convex portion for preventing a relative rotation of the magnetized body may be formed in the flange portion of the support member, and the magnetized body may be integrally injection molded with the support member, whereby a relative rotation preventing convex portion or concave portion fitted to the relative rotation preventing concave portion or convex portion of the flange portion is formed in the magnetized body.

In this case, the resin bonded magnet is integrally injection molded with the support member (the slinger), and is thereafter magnetized by the magnetizing apparatus in such a manner that the N poles and the S poles are arranged at a uniform interval.

The relative rotation preventing concave portion or convex portion may be provided in an outer peripheral surface of the flange portion, or may be provided in a side surface of the flange portion. It is preferable that the relative rotation preventing concave portion or convex portion of the flange portion of the support member is formed as a concave portion and is formed as a noncircular shape by removing a linear shape, a circular arc shape, a V shape or the like at a predetermined position (at least one position) of an outer diameter of the circular slinger. It is preferable that a number of the concave portion is set to plural number, and the concave portions are arranged at a uniform interval in a circumferential direction.

For example, the relative rotation preventing concave portion or convex portion may be provided in an outer periphery of the flange portion, and a come-off preventing portion engaging with the outer periphery of the flange portion may be formed in an outer periphery of the magnetized body, In accordance with the structure mentioned above, it is possible to securely dissolve the come-off tendency of the magnetized body which comes into question in the case of using the resin bonded magnet.

Further, an annular concave portion may be provided in a side surface of the flange portion, and one side surface of the magnetized body may be fitted to the concave portion. In accordance with the structure mentioned above, since it is possible to enlarge the thickness of the magnetized body without changing an axial dimension of the magnetized pulsar ring, it is possible to enlarge the magnetic force without changing the specification of the other structures.

Further, the relative rotation preventing concave portion or convex portion may be provided in the side surface of the flange portion. In this case, it is possible to do away with the come-off preventing portion which is provided in the outer periphery of the magnetized body and is engaged with the outer peripheral portion of the flange portion, or it is possible to set this. In accordance with the rolling bearing apparatus with sensor shown in FIG. 15, since the magnetized body is attached to one side surface, and the other side surface can be used as a sliding surface of an elastic seal, it is hard to enlarge the thickness of the come-off preventing portion engaging with the outer peripheral portion of the flange portion. Accordingly, the come-off preventing portion of the magnetized body becomes relatively weak for the thermal shock. Since the relative rotation preventing concave portion or convex portion can improve an adhesive property between the magnetized body and the support member, the come-off preventing portion may be omitted for the rolling bearing with sensor. In the case that the come-off preventing portion is provided, it is possible to securely execute both of the prevention of the relative rotation and the come-off prevention, so that an extremely high reliability can be obtained.

Further, the magnetized body may be additionally added with a linear expansion coefficient adjusting material for making a linear expansion coefficient of the magnetized body close to a linear expansion coefficient of the support member. In accordance with this structure, an amount of deformation becomes equal between the magnetized body and the support member at the thermal expanding time or the thermal contracting time, and the stress generated in the come-off preventing portion becomes small.

Further, a weld generated in the magnetized body by an influence of an injection gate position may be positioned at a convex portion of the magnetized body. As mentioned above, the relative rotation preventing concave portion or convex portion can be obtained by integrally injection molding the magnetized pulsar ring. However, in the integral injection molding, the weld is necessarily generated in the resin portion (the magnetized body) by the influence of the injection gate position. This weld corresponds to a weak position in strength in comparison with the other portions, the weld is reinforced by the convex portion by setting a manufacturing condition in such a manner that the weld is positioned at the convex portion of the magnetized body, and it is possible to improve strength of the magnetized body.

In accordance with the magnetized pulsar ring of this invention, since the magnetized body is constituted by the resin bonded magnet, it is possible to increase a scratch resistance. Further, since it is possible to absorb the difference of the amount of deformation between the support member and the magnetized body, by the elastic layer, the thermal shock resistance is improved, and it is possible to securely fix the magnetized body.

### BRIEF DESCRIPTION OF THE DRAWINGS

FIG. 1 is a cross sectional view showing a first embodiment of a magnetized pulsar ring in accordance with this invention;

FIG. 2 is a cross sectional view showing a second embodiment of the magnetized pulsar ring in accordance with this invention;

FIG. 3 is a cross sectional view showing a third embodiment of the magnetized pulsar ring in accordance with this invention;

FIG. 4 is a cross sectional view showing a fourth embodiment of the magnetized pulsar ring in accordance with this invention;

FIG. 5 is a cross sectional view showing a fifth embodiment of the magnetized pulsar ring in accordance with this invention;

FIG. 6 is a cross sectional view showing a sixth embodiment of the magnetized pulsar ring in accordance with this invention;

FIG. 7 is a cross sectional view showing a seventh embodiment of the magnetized pulsar ring in accordance with this invention;

FIG. 8 is a cross sectional view showing an eighth embodiment of the magnetized pulsar ring in accordance with this invention;

FIG. 9 is a cross sectional view showing a ninth embodiment of the magnetized pulsar ring in accordance with this invention;

FIG. 10 is an enlarged cross sectional view of a main portion in FIG. 9;

FIG. 11 is across sectional view showing a tenth embodiment of the magnetized pulsar ring in accordance with this invention;

FIG. 12 is a cross sectional view along a line XII-XII in FIG. 11;

FIG. 13 is a cross sectional view showing an eleventh embodiment of the magnetized pulsar ring in accordance with this invention;

FIG. 14 is a cross sectional view showing one example of a rolling bearing apparatus with sensor to which the magnetized pulsar ring in accordance with this invention is applied; and

FIG. 15 is a cross sectional view showing a different example of the rolling bearing apparatus with sensor to which the magnetized pulsar ring in accordance with this invention is applied.

### DETAILED DESCRIPTION OF PREFERABLE EMBODIMENTS

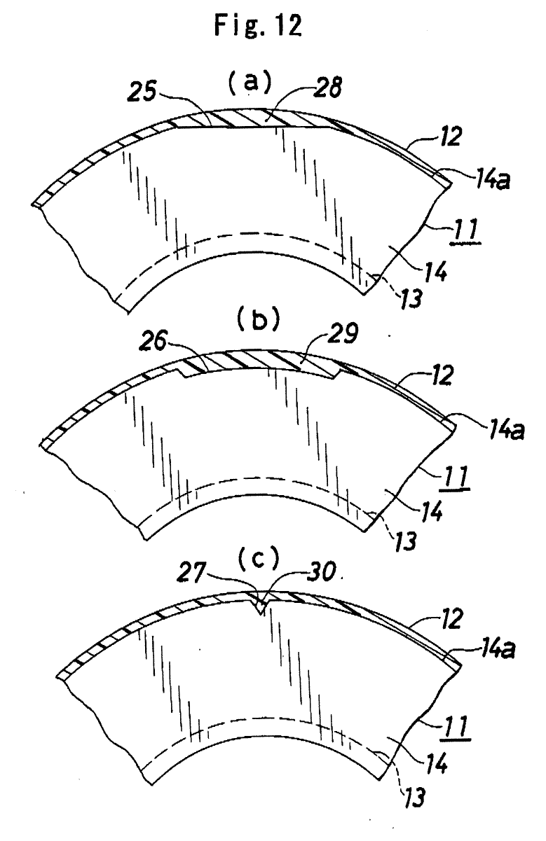

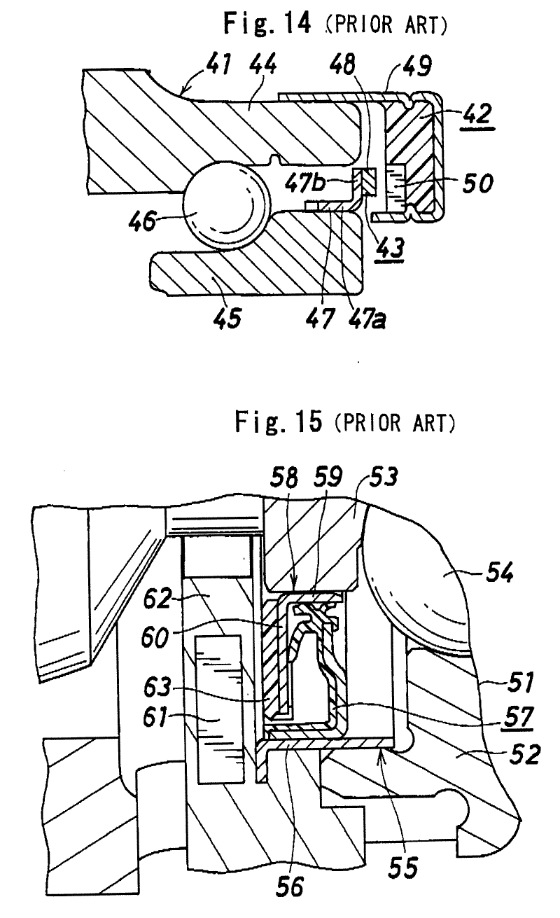

A description will be in detail given below of embodiments of this invention with reference to the accompanying drawings. In the following description, right and left respectively indicate right and left in each of the drawings except FIG. 12.

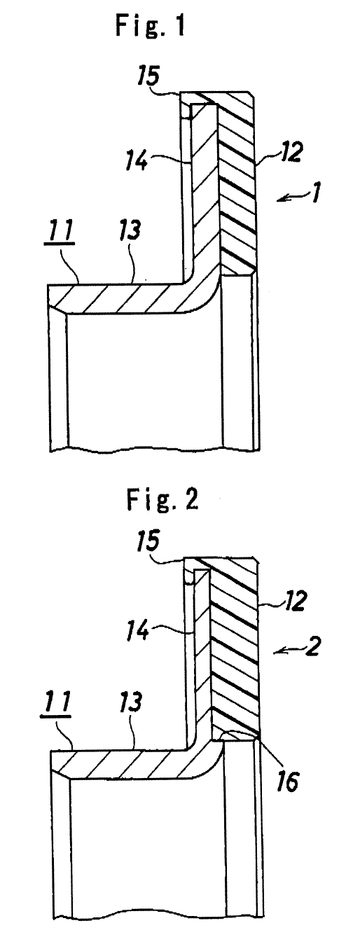

FIG. 1 shows a first embodiment of a magnetized pulsar ring in accordance with this invention.

In FIG. 1, a magnetized pulsar ring 1 is constituted by a support member 11 fixed to an inner ring, and a magnetized body 12 provided in a support member 11.

The support member 11 is constituted by a cylinder portion 13 fitted and fixed to an outer periphery of the inner ring, and an outward flange portion 14 provided in a right end portion of the cylinder portion 13.

The magnetized body 12 is constituted by a resin bonded magnet, and is fixed over an almost entire periphery of a right surface of the flange portion 14 of the support member 11 in accordance with an integral injection molding.

An outer periphery of the magnetized body 12 is provided with a come-off preventing portion 15 having an inverted-L shaped cross section and engaging with an outer peripheral portion of the flange portion 14, and the magnetized body 12 is prevented from coming off from the support member 11 by the come-off preventing portion 15.

The resin bonded magnet constituting the magnetized body 12 is additionally provided with a linear expansion coefficient adjusting material (a glass fiber, a carbon fiber or the like) making a linear expansion coefficient of the magnetized body 12 close to a linear expansion coefficient of the support member 11. A proper amount of the added linear expansion coefficient adjusting material may be determined by actually executing a thermal shock test. However, the linear expansion coefficient of the magnetized body 12 is preferably set to 1 to 2 times of the linear expansion coefficient of the support member 11, and is more preferably set to 1 to 1.5 times thereof. Accordingly, an amount of deformation becomes approximately equal between the magnetized body 12 and the support member 11 at a thermal expanding time or a thermal contracting time, and a stress generated in the come-off preventing portion 15 becomes small.

FIG. 2 shows a second embodiment of the magnetized pulsar ring in accordance with this invention.

In this drawing, a magnetized pulsar ring 2 is constituted by a support member 11 fixed to an inner ring, and a magnetized body 12 provided in a support member 11.

The support member 11 is constituted by a cylinder portion 13 fitted and fixed to an outer periphery of the inner ring, and an outward flange portion 14 provided in a right end portion of the cylinder portion 13.

The magnetized body 12 is constituted by a resin bonded magnet, and is fixed over an almost entire periphery of a right surface of the flange portion 14 of the support member 11 in accordance with an integral injection molding.

An outer periphery of the magnetized body 12 is provided with a come-off preventing portion 15 having an inverted-L shaped cross section and engaging with an outer peripheral portion of the flange portion 14, and the magnetized body 12 is prevented from coming off from the support member 11 by the come-off preventing portion 15.

Further, an annular concave portion 16 is provided in a right surface of the flange portion 14. An inner diameter of the concave portion 16 is set to be equal to an inner diameter of the magnetized body 12, and one side surface (a left surface) of the magnetized body 12 is fitted into the concave portion 16.

A linear expansion coefficient adjusting material (a glass fiber, a carbon fiber or the like) is added to the resin bonded magnet constituting the magnetized body 12 in the same manner as the first embodiment.

An axial dimension of the magnetized pulsar ring 2 in accordance with the second embodiment is set to be equal to an axial dimension of the magnetized pulsar ring 1 in accordance with the first embodiment, and both pulsar rings are different in a point that the concave portion 16 is provided or is not provided in the side surface of the flange portion 14. Accordingly, in the structure in accordance with the second embodiment provided with the concave portion 16, the thickness of the magnetized body 12 is enlarged, and a magnetic force is enlarged at that degree.

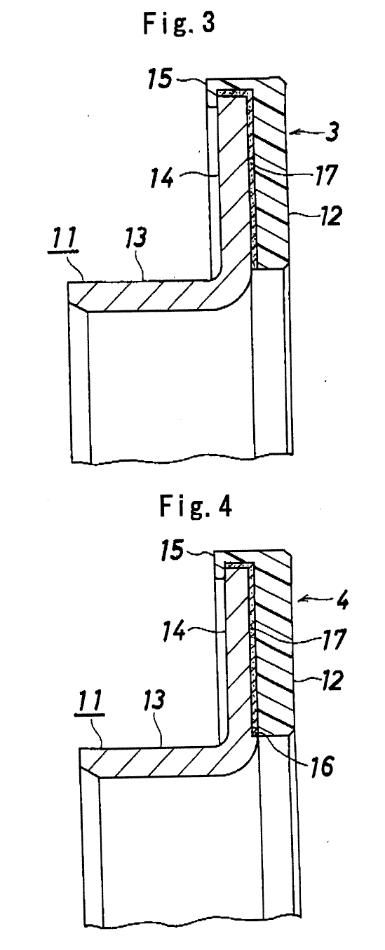

FIG. 3 shows a third embodiment of the magnetized pulsar ring in accordance with this invention.

In FIG. 3, a magnetized pulsar ring 3 is constituted by a support member 11 fixed to an inner ring, and a magnetized body 12 provided in a support member 11.

The support member 11 is constituted by a cylinder portion 13 fitted and fixed to an outer periphery of the inner ring, and an outward flange portion 14 provided in a right end portion of the cylinder portion 13,

The magnetized body 12 is constituted by a resin bonded magnet, and is fixed over an almost entire periphery of a right surface of the flange portion 14 of the support member 11 in accordance with an integral injection molding.

An outer periphery of the magnetized body 12 is provided with a come-off preventing portion 15 hating an inverted-L shaped cross section and engaging with an outer peripheral portion of the flange portion 14, and the magnetized body 12 is prevented from coming off from the support member 11 by the come-off preventing portion 15.

An elastic layer 17 is interposed between the magnetized body 12 and the flange portion 14. The elastic layer 17 is constituted by a thin rubber sheet, and is provided not only between a side surface of the magnetized body 12 and a side surface of the flange portion 14, but also between an outer peripheral surface of the flange portion 14 and the come-off preventing portion 15 of the magnetized body 12. The elastic layer 17 absorbs a difference between an amount of deformation of the magnetized body 12 and an amount of deformation of the support member 11, whereby a stress generated in the come-off preventing portion 15 is generated becomes small.

FIG. 4 shows a fourth embodiment of the magnetized pulsar ring in accordance with this invention.

In FIG. 4, a magnetized pulsar ring 4 is constituted by a support member 11 fixed to an inner ring, and a magnetized body 12 provided in a support member 11.

The support member 11 is constituted by a cylinder portion 13 fitted and fixed to an outer periphery of the inner ring, and an outward flange portion 14 provided in a right end portion of the cylinder portion 13.

The magnetized body 12 is constituted by a resin bonded magnet and is fixed over an almost entire periphery of a right surface of the flange portion 14 of the support member 11 in accordance with an integral injection molding,

An outer periphery of the magnetized body 12 is provided with a come-off preventing portion 15 having an inverted-L shaped cross section and engaging with an outer peripheral portion of the flange portion 14, and the magnetized body 12 is prevented from coming off from the support member 11 by the come-off preventing portion 15.

An elastic layer 17 is interposed between the magnetized body 12 and the flange portion 14. The elastic layer 17 is constituted by a thin rubber sheet, and is provided not only between a side surface of the magnetized body 12 and a side surface of the flange portion 14, but also between an outer peripheral surface of the flange portion 14 and the come-off preventing portion 15 of the magnetized body 12. The elastic layer 17 absorbs a difference between an amount of deformation of the magnetized body 12 and an amount of deformation of the support member 11, whereby a stress generated in the come-off preventing portion 15 is generated becomes small.

Further, an annular concave portion 16 is provided in a right surface of the flange portion 14. An inner diameter of the concave portion 16 is set to be equal to an inner diameter of the magnetized body 12, a depth thereof is set to be equal to a thickness of the elastic layer 12, and the elastic layer 12 is fitted into the concave portion 16.

An axial dimension of the magnetized pulsar ring 4 in accordance with the fourth embodiment is set to be equal to an axial dimension of the magnetized pulsar ring 3 in accordance with the third embodiment, and both pulsar rings are different in a point that the concave portion 16 is provided or is not provided in the side surface of the flange portion 14. Accordingly, in the structure in accordance with the fourth embodiment provided with the concave portion 16, the thickness of the magnetized body 12 is equal to that of the magnetized pulsar ring 1 in accordance with the first embodiment, in spite that the elastic layer 12 is provided.

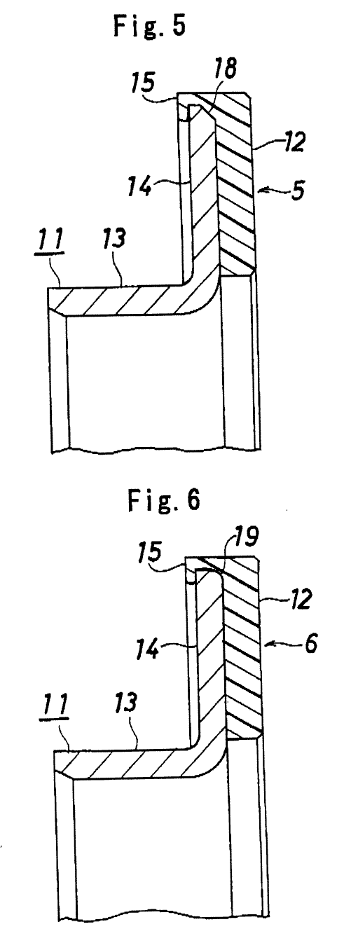

FIG. 5 shows a fifth embodiment of the magnetized pulsar ring in accordance with this invention.

In FIG. 5, a magnetized pulsar ring 5 is constituted by a support member 11 fixed to an inner ring, and a magnetized body 12 provided in a support member 11,

The support member 11 is constituted by a cylinder portion 13 fitted and fixed to an outer periphery of the inner ring, and an outward flange portion 14 provided in a right end portion of the cylinder portion 13.

The magnetized body 12 is constituted by a resin bonded magnet, and is fixed over an almost entire periphery of a right surface of the flange portion 14 of the support member 11 in accordance with an integral injection molding.

An outer periphery of the magnetized body 12 is provided with a come-off preventing portion 15 having an inverted-L shaped cross section and engaging with an outer peripheral portion of the flange portion 14, and the magnetized body 12 is prevented from coming off from the support member 11 by the come-off preventing portion 15.

A right corner portion in an outer periphery of the flange portion 14 of the support member 11 is chamfered by a flat slope surface 18. Accordingly, a stress applied to the come-off preventing portion 15 is dispersed, it is possible to make the come-off preventing portion 15 thick, and the stress generated in the come-off preventing portion 15 becomes small.

FIG. 6 shows a sixth embodiment of the magnetized pulsar ring in accordance with this invention. In the following description, the same reference numerals are attached to the same structures as those of the fifth embodiment and a description thereof will be omitted.

In a magnetized pulsar ring 6 in accordance with this embodiment, a right corner portion in an outer periphery of the flange portion 14 of the support member 11 is chamfered by a curved surface 19. Accordingly, a stress applied to the come-off preventing portion 15 is dispersed, it is possible to make the come-off preventing portion 15 thick, and the stress generated in the come-off preventing portion 15 becomes small.

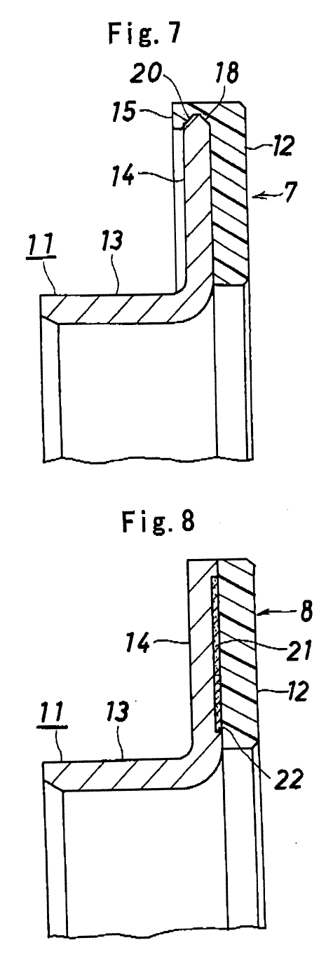

FIG. 7 shows a seventh embodiment of the magnetized pulsar ring in accordance with this invention. In the following description, the same reference numerals are attached to the same structures as those of the fifth embodiment and a description thereof will be omitted.

In a magnetized pulsar ring 7 in accordance with this embodiment, a right corner portion in an outer periphery of the flange portion 14 of the support member 11 is chamfered by a flat slope surface 18, and a left corner portion in the outer periphery is chamfered by a flat slope surface 2O. Accordingly, a stress applied to the come-off preventing portion 15 is dispersed, it is possible to make the come-off preventing portion 15 thick, and the stress generated in the come-off preventing portion 15 becomes small.

In this case, in the fifth to seventh embodiments, the structure may be made such that the linear expansion coefficient adjusting material may be added to the resin bonded magnet constituting the magnetized body 12, or the structure may be made such that the elastic layer 17 is interposed between the magnetized body 12 and the flange portion 14, It is possible to obtain the magnetized pulsar ring having a higher reliability by executing a combination of the embodiments mentioned above,

FIG. 8 shows an eighth embodiment of the magnetized pulsar ring in accordance with this invention.

In the drawing, a magnetized pulsar ring 8 is constituted by a support member 11 fixed to an inner ring, and a magnetized body 12 provided in a support member 11.

The support member 11 is constituted by a cylinder portion 13 fitted and fixed to an outer periphery of the inner ring, and an outward flange portion 14 provided in a right end portion of the cylinder portion 13.

The magnetized body 12 is constituted by a resin bonded magnet, and is fixed over an almost entire periphery of a right surface of the flange portion 14 of the support member 11 by an adhesive agent layer 21.

An annular concave portion 22 is provided in a right surface of the flange portion 14. A dimension of the concave portion 22 corresponds to a dimension of the adhesive agent layer 21, and an entire of the adhesive agent layer 21 is fitted into the concave portion 22. A thickness of the magnetized body 12 is equal to that shown in FIG. 4 (the fourth embodiment), and a magnetic force is larger than that shown in FIG. 3 (the third embodiment). On the other hand, the come-off preventing portion 15 provided in the first to seventh embodiments mentioned above is omitted, and it is possible to prevent the magnetized body 12 from coming off from the support member 11 by the adhesive agent layer 21.

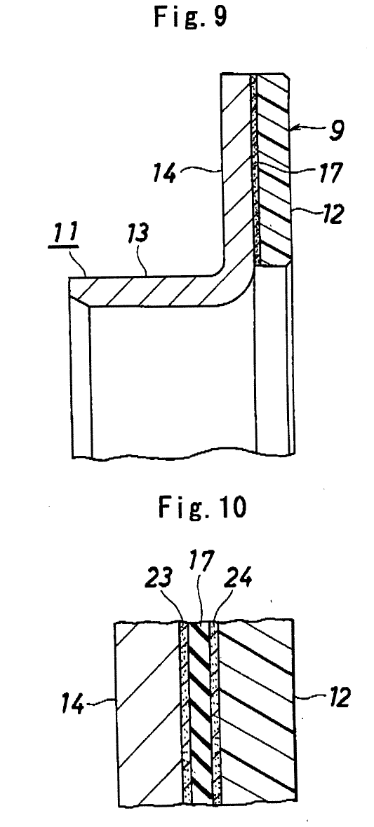

FIG. 9 shows a ninth embodiment of the magnetized pulsar ring in accordance with this invention.

In the drawing, a magnetized pulsar ring 9 is constituted by a support member 11 fixed to an inner ring, and a magnetized body 12 provided in a support member 11.

The support member 11 is constituted by a cylinder portion 13 fitted and fixed to an outer periphery of the inner ring, and an outward flange portion 14 provided in a right end portion of the cylinder portion 13.

The magnetized body 12 is constituted by a resin bonded magnet, and an intermediate elastic layer 17 made of a rubber is interposed between the magnetized body 12 and the flange portion 14 of the support member 11. Further, the come-off preventing portion 15 is omitted in the same manner as the eighth embodiment.

As in detail shown in FIG. 10, adhesive agent layers 23 and 24 are formed in both sides of the intermediate elastic layer 17 so as to form a three-layer structure, and the magnetized body 12 is prevented from coming off from the support member 11 by these adhesive agent layers 23 and 24. The adhesive agent layer 23 brought into contact with the outward flange portion 14 of the support member 11 is formed as an adhesive agent which is compatible with a metal, and the adhesive agent layer 24 brought into contact with the magnetized body 12 is formed as an adhesive agent which is compatible with a resin. The adhesive agent layers 23 and 24 also serve as an elastic layer, and a difference of the linear expansion coefficient between the support member 11 and the magnetized body 12 is absorbed by both of the intermediate elastic layer 17 and the adhesive agent layers 23 and 24. The intermediate elastic layer 17 may be constituted by a third adhesive agent layer or a resin layer in place of the layer made of the rubber.

In this case, the three-layer structure shown in FIG. 10 can be applied to the embodiment having the come-off preventing portion 15 shown in FIGS. 3 and 4. In accordance with this structure, it is possible to further absorb the difference of the linear expansion coefficient between the support member 11 and the magnetized body 12, and it is possible to further firmly fix the magnetized body 12 to the support member 11.

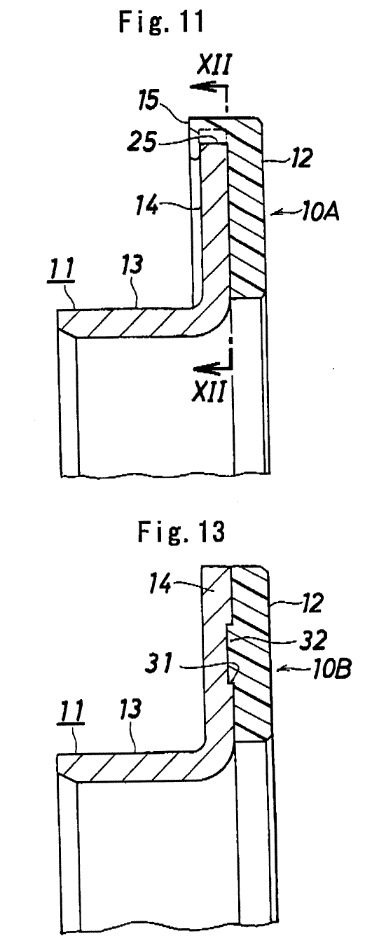

FIGS. 11 and 12 show a tenth embodiment of the magnetized pulsar ring in accordance with this invention.

In FIG. 11, a magnetized pulsar ring 10A is constituted by a support member 11 fixed to an inner ring, and a magnetized body 12 provided in a support member 11.

The support member 11 is constituted by a cylinder portion 13 fitted and fixed to an outer periphery of the inner ring, and an outward flange portion 14 provided in a right end portion of the cylinder portion 13.

The magnetized body 12 is constituted by a resin bonded magnet, and is fixed over an almost entire periphery of a right surface of the flange portion 14 of the support member 11 in accordance with an integral injection molding

An outer periphery of the magnetized body 12 is provided with a come-off preventing portion 15 having an inverted-L shaped cross section and engaging with an outer peripheral portion of the flange portion 14, and the magnetized body 12 is prevented from coming off from the support member 11 by the come-off preventing portion 15.

As shown in FIGS. 12(a), 12(b) and 12(c), an outer peripheral surface 14a of the flange portion 14 of the support member 11 is not formed in a circular shape, but is formed in a shape obtained by cutting a part of a circumference thereof at a predetermined interval. Accordingly, relative rotation preventing concave portions 25, 26 and 27 preventing a relative rotation of the magnetized body 12 are formed in the flange portion 14 of the support member 11. Relative rotation preventing convex portions 28, 29 and 30 are formed in the magnetic body 12 by integrally injection molding the magnetic body 12 in the support member 11. The relative rotation preventing convex portions 28, 29 and 30 are fitted to the relative rotation preventing concave portions 25, 26 and 27 of the flange portion 14. The relative rotation preventing concave portions 25, 26 and 27 may be formed by cutting the outer peripheral surface 14a of the flange portion 14 in a linear shape, as shown in FIG. 12(a), or may be formed by cutting the outer peripheral surface 14a of the flange portion 14 in a circular arc shape, as shown in FIG. 12(b), or may be formed by cutting the outer peripheral surface 14a of the flange portion 14 in a V shape, as shown in FIG. 12(c). In other words, various shapes can be employed as far as the outer peripheral surface 14a of the flange portion 14 is formed as a noncircular shape. Further, the number of the relative rotation preventing concave portions 25, 26 and 27 is at least one, and is preferably set to plural number, and a plurality of relative rotation preventing concave portions are provided at a uniform interval in a peripheral direction.

The structure of the relative rotation preventing concave portions 25, 26 and 27 and the relative rotation preventing convex portions 28, 29 and 30 shown in FIGS. 12(a), 12(b) and 12(c) can be combined with each of the first to seventh embodiments provided with the come-off preventing portion 15, although an illustration will be omitted.

FIG. 13 shows an eleventh embodiment of the magnetized pulsar ring in accordance with this invention.

In FIG. 13, a magnetized pulsar ring 10B is constituted by a support member 11 fixed to an inner ring, and a magnetized body 12 provided in a support member 11.

The support member 11 is constituted by a cylinder portion 13 fitted and fixed to an outer periphery of the inner ring, and an outward flange portion 14 provided in a right end portion of the cylinder portion 13.

The magnetized body 12 is constituted by a resin bonded magnet, and is fixed over an almost entire periphery of a right surface of the flange portion 14 of the support member 11 in accordance with an integral injection molding.

In this embodiment, the come-off preventing portion 15 is removed. Further, a relative rotation preventing concave portion 31 is provided in a right surface of the flange portion 14. The relative rotation preventing concave portion 31 is formed in a square shape or a fan shape, and a plurality of (for example, four) relative rotation preventing concave portions 31 are provided at a uniform interval in a peripheral direction. Relative rotation preventing convex portions 32 are formed in the magnetic body 12 by integrally injection molding the magnetic body 12 in the support member 11. The relative rotation preventing convex portions 32 are fitted to the relative rotation preventing concave portions 31 of the flange portion 14, The structure of the relative rotation preventing concave portions 31 and the relative rotation preventing convex portions 32 can be combined with each of the eight hand ninth embodiments provided with no come-off preventing portion 15, although an illustration will be omitted. In this eleventh embodiment, the come-off preventing portion 15 may be, of course, added.

In this case, the resin bonded magnet constituting the magnetized body 12 is made of rare earth magnetic powders (or ferrite powders)+resin. However, it is possible to add the linear expansion coefficient adjusting material (the glass fiber, the carbon fiber or the like) making the linear expansion coefficient of the magnetized body 12 close to the linear expansion coefficient of the support member 11. Accordingly, the thermal shock resistance of the magnetized body 12 or the like is further improved.

The magnetized pulsar rings 10A and 10B in accordance with the tenth and eleventh embodiments mentioned above are manufactured in accordance with the integral injection molding of arranging the support member 11 within a cavity formed in a metal mold, and injecting a resin bonded magnetic material from an injection gate provided in the metal mold. At this time, a manufacturing condition is set in such a manner that a weld generated in the magnetized body 12 by an influence of a position of the injection gate is positioned at the convex portions 28, 29, 30 and 32 of the magnetized body 12. In the case that the injection gate is provided at one position, and the resin is separated into two directions so as to be filled within the cavity, a combined portion of the resin is generated near opposite positions (positioned spaced at 180 degree) of the injection gate, and the combined portion (called as “weld”) comes to a position in which the strength is weaker in comparison with the other portions. In the magnetized pulsar rings 10A and 10B in accordance with the respective embodiments, since the relative rotation preventing convex portions 28, 29, 30 and 32 have the relatively larger strength, it is possible to obtain the magnetized pulsar rings 10A and 10B having no weak position in strength, by aligning them with the weld, The number of the injection gate is not limited to one, and the weld generating position is changed in accordance with the manufacturing condition. However, a length, a number and an arranged position of the relative rotation preventing convex portions 28, 29, 30 and 32 can be optionally set, and can be easily aligned with the weld,

What is claimed is:

1. A magnetized pulsar ring comprising:
a support member including a cylinder portion and a flange portion provided in one end of the cylinder portion; and
a disc-shaped magnetized body provided in the flange portion of the support member,
wherein the magnetized body is constituted by a resin bonded magnet, and an elastic layer is interposed between the magnetized body and the flange portion.

2. A magnetized pulsar ring as claimed in claim 1, wherein the magnetized body is fixed to the support member in accordance with an integral injection molding, in such a manner that a come-off preventing portion that engages with an outer peripheral portion of the flange portion is formed in an outer periphery of the magnetized body.

3. A magnetized pulsar ring as claimed in claim 1, wherein a linear expansion coefficient adjusting material making a linear expansion coefficient of the magnetized body close to a linear expansion coefficient of the support member is added to the magnetized body.

4. A magnetized pulsar ring as claimed in claim 2, wherein a corner portion of the flange portion is chamfered.

5. A magnetized pulsar ring as claimed in claim 1, wherein a side surface of the flange portion has a concave portion having a depth corresponding to the thickness of the elastic layer.

6. A magnetized pulsar ring as claimed in claim 1, wherein the magnetized pulsar ring includes a first adhesive agent layer adhered to the support member, a second adhesive agent layer adhered to the magnetized body, and an elastic layer interposed between both the adhesive agent layers.

7. A magnetized pulsar ring as claimed in claim 1, wherein a relative rotation preventing concave portion or convex portion for preventing a relative rotation of the magnetized body is formed in the flange portion of the support member, and the magnetized body is integrally injection molded with the support member, whereby a relative rotation preventing convex portion or concave portion fitted to the relative rotation preventing concave portion or convex portion of the flange portion is formed in the magnetized body.

8. A magnetized pulsar ring as claimed in claim 7, wherein the relative rotation preventing concave portion or convex portion is provided in an outer periphery of the flange portion, and a come-off preventing portion engaging with the outer periphery of the flange portion is formed in an outer periphery of the magnetized body.

9. A magnetized pulsar ring as claimed in claim 7, wherein an annular concave portion is provided in a side surface of the flange portion, and one side surface of the magnetized body is fitted to the concave portion.

10. A magnetized pulsar ring as claimed in claim 7, wherein the relative rotation preventing concave portion or convex portion is provided in the side surface of the flange portion.

11. A magnetized pulsar ring as claimed in claim 7, wherein the magnetized body is additionally added with a linear expansion coefficient adjusting material for making a linear expansion coefficient of the magnetized body close to a linear expansion coefficient of the support member.

12. A magnetized pulsar ring as claimed in claim 7, wherein a weld generated in the magnetized body by an influence of an injection gate position is positioned at a convex portion of the magnetized body.
